(19) United States
(12) Patent Application Publication
(10) Pub. No.: US 2019/0246042 A1
(43) Pub. Date: Aug. 8, 2019

(54) PHOTOGRAPHING COMPOSITION METHOD AND APPARATUS, MOVABLE OBJECT AND COMPUTER-READABLE STORAGE MEDIUM

(71) Applicant: AUTEL ROBOTICS CO., LTD., Shenzhen (CN)

(72) Inventor: Yang LIU, Shenzhen (CN)

(21) Appl. No.: 16/386,997

(22) Filed: Apr. 17, 2019

Related U.S. Application Data
(63) Continuation of application No. PCT/CN2017/106749, filed on Oct. 18, 2017.

(30) Foreign Application Priority Data
Oct. 19, 2016 (CN) 201610913442.4

(51) Int. Cl. H04N 5/232; G06T 7/73; G06T 7/80; G06K 9/00

(52) U.S. Cl. CPC H04N 5/23299; G06T 7/75; G06T 2207/30244; G06K 9/00624; G06T 7/80

(57) ABSTRACT

The present application discloses a photographing composition method and apparatus, a movable object and a computer-readable storage medium. A first image of a target scene photographed by a photographing apparatus is acquired. Then, a composition model related to the first image is determined according to the first image. Finally, an attitude of the photographing apparatus is adjusted according to the composition model and the first image, so that the photographing apparatus acquires a second image matching the composition model. In this way, an image having better composition can be taken and operations are simple and convenient.

### CROSS-REFERENCE

This application is a continuation of International Application No. PCT/CN2017/106749 filed on Oct. 18, 2017, which claims priority to Chinese Application No. CN2016109134424 filed on Oct. 19, 2016, both of which are hereby incorporated by reference in their entireties.

### TECHNICAL FIELD

The present application relates to the field of image capturing technologies, and in particular, to a photographing composition method and apparatus, a movable object and a computer-readable storage medium.

### RELATED ART

In the prior art, when an aerial vehicle or a handheld gimbal uses an on-board camera to take a photograph, scene composition needs to be often performed to take a more professional and aesthetically pleasing image.

First, the aerial vehicle needs to perform a plurality of flight tests and adjust an attitude to obtain an optimal photographing angle. This consumes an electricity quantity of the aerial vehicle and increases the control difficulty of the aerial vehicle. If it is expected to photograph a scene well by using the handheld gimbal, an attitude of the handheld gimbal needs to be often adjusted. This consumes a large amount of time and energy of an operator and the operator cannot focus on creation. Second, composition is an aesthetics design, and it is difficult for an ordinary user to grasp a composition design in a short time.

### SUMMARY

Technical problems mainly to be resolved in implementations of the present application are to provide a photographing composition method and apparatus, a movable object and a computer-readable storage medium for which operations are simple and convenient and by using which an optimal photographing composition design can be provided and a more professional image can be taken according to the photographing composition design.

According to a first aspect, an embodiment of the present application provides a photographing composition method, including:

acquiring a first image of a target scene photographed by a photographing apparatus;

determining a composition model related to the first image according to the first image; and

adjusting an attitude of the photographing apparatus according to the composition model and the first image, so that the photographing apparatus acquires a second image matching the composition model.

In an embodiment of the present application, the determining the composition model related to the first image according to the first image includes:

identifying, according to the first image, a type to which the target scene belongs; and

determining the composition model related to the target scene according to the type to which the target scene belongs.

In an embodiment of the present application, the adjusting the attitude of the photographing apparatus according to the composition model and the first image, so that the photographing apparatus acquires the second image matching the composition model includes:

determining an offset parameter of the first image relative to the composition model; and

adjusting the attitude of the photographing apparatus according to the offset parameter, so that the photographing apparatus acquires the second image matching the composition model.

In an embodiment of the present application, the method further includes:

determining a photographing parameter related to the composition model according to the composition model; and

acquiring, according to the photographing parameter, the second image matching the composition model.

In an embodiment of the present application, the photographing parameter includes at least one of a focal length, chromaticity, brightness, contrast and an exposure level.

According to a second aspect, an embodiment of the present application provides a movable object, including a body, a controller disposed in the body and a photographing apparatus disposed on the body, where the controller is configured to:

acquire a first image of a target scene photographed by the photographing apparatus;

determine a composition model related to the first image according to the first image; and

adjust an attitude of the photographing apparatus according to the composition model and the first image, so that the photographing apparatus acquires a second image matching the composition model.

In an embodiment of the present application, the controller is specifically configured to:

identify, according to the first image, a type to which the target scene belongs; and

determine the composition model related to the target scene according to the type to which the target scene belongs.

In an embodiment of the present application, the controller is specifically configured to:

determine an offset parameter of the first image relative to the composition model; and

adjust the attitude of the photographing apparatus according to the offset parameter, so that the photographing apparatus acquires the second image matching the composition model.

In an embodiment of the present application, the controller is specifically configured to:

determine a photographing parameter related to the composition model according to the composition model; and

control the photographing apparatus to acquire, according to the photographing parameter, the second image matching the composition model.

In an embodiment of the present application, the photographing parameter includes at least one of a focal length, chromaticity, brightness, contrast and an exposure level.

In an embodiment of the present application, the movable object further includes a memory configured to store the composition model.

In an embodiment of the present application, the movable object includes an aerial vehicle or a handheld photographing device.

According to a third aspect, an embodiment of the present application provides a photographing composition apparatus. The apparatus includes:

an acquiring module, configured to acquire a first image of a target scene photographed by a photographing apparatus;

a model determining module, configured to determine a composition model related to the first image according to the first image; and

an attitude adjustment module, configured to adjust an attitude of the photographing apparatus according to the composition model and the first image, so that the photographing apparatus acquires a second image matching the composition model.

In an embodiment of the present application, the model determining module includes:

a scene identification module, configured to identify a type to which the target scene belongs; and

a determining module, configured to determine the composition model related to the first image.

In an embodiment of the present application, the apparatus further includes:

an offset parameter determining module, configured to determine an offset parameter of the first image relative to the composition model; and

the attitude adjustment module is configured to adjust the attitude of the photographing apparatus according to the offset parameter, so that the photographing apparatus acquires the second image matching the composition model.

In an embodiment of the present application, the apparatus further includes:

a photographing parameter determining module, configured to determine a photographing parameter related to the composition model according to the composition model; and

the attitude adjustment module is configured to acquire, according to the photographing parameter, the second image matching the composition model.

In an embodiment of the present application, the photographing parameter includes at least one of a focal length, chromaticity, brightness, contrast and an exposure level.

In an embodiment of the present application, the apparatus further includes a storage module configured to store the composition model.

According to a fourth aspect, an embodiment of the present application provides a movable object, including a memory and a processor, where the memory stores a computer program, and when the computer program is executed by the processor, the processor is caused to perform the photographing composition method described above.

According to a fifth aspect, an embodiment of the present application provides a computer-readable storage medium storing a computer program, where when the computer program is executed by a processor, the processor is caused to perform the photographing composition method described above.

The embodiments of the present application disclose the photographing composition method and apparatus, the movable object and the computer-readable storage medium. The first image of the target scene photographed by the photographing apparatus is acquired. Then, the composition model related to the first image is determined according to the first image. Finally, the attitude of the photographing apparatus is adjusted according to the composition model and the first image, so that the photographing apparatus acquires the second image matching the composition model. In this way, an image having better composition can be taken and operations are simple and convenient.

### BRIEF DESCRIPTION OF THE DRAWINGS

To describe the technical solutions in the embodiments of the present application more clearly, the following briefly describes the accompanying drawings required for describing the embodiments of the present application. Apparently, the accompanying drawings in the following descriptions show merely some embodiments of the present application, and a person of ordinary skill in the art may still derive other drawings from these accompanying drawings without creative efforts.

FIG. 1 is a schematic structural diagram of a movable object according to an embodiment of the present application;

FIG. 2 is a flowchart of a photographing composition method according to an embodiment of the present application;

FIG. 3 is a flowchart of a photographing composition method according to another embodiment of the present application;

FIG. 4 is a functional block diagram of a photographing composition apparatus according to an embodiment of the present application;

FIG. 5 is a functional block diagram of a photographing composition apparatus according to another embodiment of the present application; and

FIG. 6 is a schematic diagram of a hardware structure of a movable object according to an embodiment of the present application.

### DETAILED DESCRIPTION

To make the objectives, technical solutions and advantages of the present application clearer, the present application is further described in detail below with reference to the accompanying drawings and the embodiments. It should be understood that the specific embodiments described herein are merely intended to explain the present application, but are not intended to limit the present application.

In addition, the following described technical characteristics in various implementations of the present application may be mutually combined as long as they do not conflict with each other.

The present application provides a photographing composition method and apparatus and a movable object using the photographing composition method or apparatus. According to the photographing composition method or apparatus, an optimal composition design and photographing parameter may be matched according to different photography scenes, and an attitude of the movable object is adjusted, to obtain an image having a better composition design.

The movable object includes a body and a photographing apparatus set on the body. In an embodiment of the present application, the movable object is an aerial vehicle 10. In other possible embodiments, the movable object may also be a handheld gimbal photographing device, a manned aerial vehicle, a navigation model, an unmanned airship, a fixed-wing unmanned aerial vehicle, an unmanned hot air balloon, or the like.

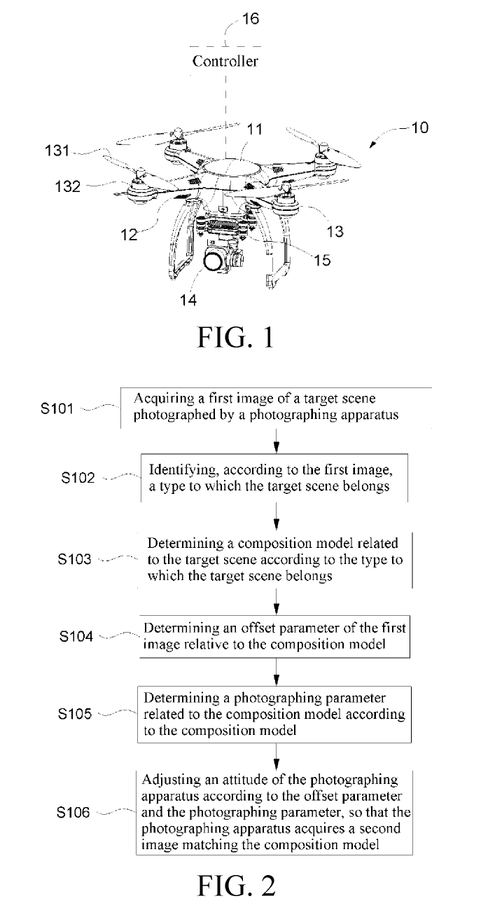

As shown in FIG. 1, the aerial vehicle 10 includes a housing 11, an arm 12 connected to the housing 11, a power apparatus 13 disposed on one end of the arm 12, a gimbal 15 connected to the housing 11, a photographing apparatus 14 connected to the gimbal 13 and a controller 16 set inside the housing 11.

In this embodiment, a quantity of arms 12 is 4, that is, the aerial vehicle is a four-rotor aerial vehicle. In other possible embodiments, a quantity of arms 12 may also be 3, 6, 8, 10, or the like.

The power apparatus 13 includes a motor 132 disposed on one end of the arm 12 and a propeller 131 connected to a rotation shaft of the motor 132. The rotation shaft of the motor 132 rotates to drive the propeller 131 to rotate, to provide a lifting force for the aerial vehicle 10.

The gimbal 15 is configured to reduce or even eliminate vibration transferred by the power apparatus 13 to the photographing apparatus 14, to ensure that the photographing apparatus 14 can take a stable and clear image or video.

The photographing apparatus 14 may be a device similar to a binocular camera, a monocular camera, an infrared imaging device, an ultraviolet imaging device, a camcorder, or the like. The photographing apparatus 14 may be directly carried on the aerial vehicle 10 or may be carried by using the gimbal 15 in this embodiment.

After the aerial vehicle 10 takes off, the photographing apparatus 14 is started by roughly aligning with a to-be-photographed target scene. The controller 16 acquires a first image of the target scene photographed by the photographing apparatus. In an embodiment of the present application, the target scene may be a scene using a beach as a background, a scene using a building as a background, a scene using a remote mountain as a background, a scene using a mountain and a river as well as a building as a background, or the like. The first image may be a single-frame image of the target scene captured by the photographing apparatus.

The controller 16 identifies, according to the first image, a type to which the target scene belongs. The controller 16 may identify the first image according to an existing known technology, and classify the target scene in the first image according to an identification result. For example, when it is identified that the first image includes a building, the first image may be classified into an architecture category; when it is identified that the first image includes a person, the first image may be classified into a figure category; and when it is identified that the first image includes a mountain and a river, the first image may be classified into a landscape category.

After determining the type to which the target scene belongs, the controller 16 may provide a composition model related to the target scene according to the type to which the target scene belongs. In this embodiment of the present application, the composition model may be various composition models such as a composition model in which a person uses a beach as a background, a composition model in which a person uses a building as a background, a composition model in which a person uses a remote mountain as a background and a composition model in which a person uses a mountain and a river and a building as a background. The composition model may include feature information of the target scene, outer contour information of a portrait, position information of the portrait in the target scene, and the like. In an embodiment of the present application, the aerial vehicle 10 may further include a memory configured to store the composition model. The foregoing described composition model may be stored in the memory.

There may be a plurality of composition models. In this case, a user may select an optimal composition model according to an actual requirement. Alternatively, the aerial vehicle 10 may autonomously select an optimal composition model according to a prestored policy. Although composition is an aesthetic design, there are still rules to follow. A training model using a scene identification technology may be formed for the rules. A machine learning method may be used to perform machine training on the scenes. The scenes are finally identified and reference composition designs may be provided.

In an embodiment of the present application, after determining the composition model, the controller 16 further determines an offset parameter of the first image relative to the composition model. This is because the first image captured by the photographing apparatus is inevitably different from the composition model. For example, the first image has a particular steep angle relative to a horizontal plane. For another example, an outer contour of a portrait in the first image is excessively large or small. For another example, the portrait in the first image is located to the left or right. Therefore, the controller 16 provides the offset parameter of the first image relative to the composition model, to provide a basis for a subsequent adjustment of the attitude of the aerial vehicle 10.

In addition, in an embodiment of the present application, the controller 16 may further determine a photographing parameter related to the composition model according to the determined composition model. The photographing parameter may include at least one of a focal length, chromaticity, brightness, contrast and an exposure level.

After determining the offset parameter and the photographing parameter, the controller 16 may adjust an attitude of the photographing apparatus 14 by adjusting a stability augmentation component, for example, the gimbal 15, of the aerial vehicle 10, a distance from the aerial vehicle 10 to the target scene, the photographing parameter of the photographing apparatus 14, or the like. When an optimal photographing attitude or an optimal photographing point is reached, the aerial vehicle 10 automatically photographs the target scene so that the photographing apparatus 14 acquires a second image matching the composition model.

Therefore, the aerial vehicle 10 in the present application may match an optimal composition design and photographing parameter according to different photography scenarios. The attitude of the aerial vehicle 10 is adjusted to obtain an image having a better composition design.

As shown in FIG. 2, an embodiment of the present application provides a photographing composition method. The method may be applied to a movable object. The movable object has a photographing apparatus. The method includes:

S101. Acquiring a first image of a target scene photographed by a photographing apparatus.

In an embodiment of the present application, the target scene may be a scene using a beach as a background, a scene using a building as a background, a scene using a remote mountain as a background, a scene using a mountain and a river and a building as a background, or the like. The first image may be a single-frame image of the target scene captured by the photographing apparatus.

S102. Identifying, according to the first image, a type to which the target scene belongs.

The first image may be identified according to an existing known technology, and the target scene in the first image may be classified according to an identification result. For example, when it is identified that the first image includes a building, the first image may be classified into an architecture category; when it is identified that the first image includes a person, the first image may be classified into a figure category; and when it is identified that the first image includes a mountain and a river, the first image may be classified into a landscape category.

S103. Determining a composition model related to the target scene according to the type to which the target scene belongs.

After the type to which the target scene belongs is determined, the composition model related to the target scene may be provided according to the type to which the target scene belongs. In this embodiment of the present application, the composition model may be various composition models such as a composition model in which a person uses a beach as a background, a composition model in which a person uses a building as a background, a composition model in which a person uses a remote mountain as a background and a composition model in which a person uses a mountain and a river and a building as a background. The composition model may include feature information of the target scene, outer contour information of a portrait, position information of the portrait in the target scene, and the like.

There may be a plurality of composition models. In this case, a user may select an optimal composition model according to an actual requirement. Alternatively, the movable object may autonomously select an optimal composition model according to a prestored policy.

S104. Determining an offset parameter of the first image relative to the composition model.

The first image captured by the photographing apparatus is inevitably different from the composition model. For example, the first image has a particular steep angle relative to a horizontal plane. For another example, an outer contour of a portrait in the first image is excessively large or small. For another example, the portrait in the first image is located to the left or right. The offset parameter of the first image relative to the composition model may provide a basis for a subsequent adjustment of an attitude of the movable object.

S105. Determining a photographing parameter related to the composition model according to the composition model. The photographing parameter may include at least one of a focal length, chromaticity, brightness, contrast and an exposure level.

S106. Adjusting an attitude of the photographing apparatus according to the offset parameter and the photographing parameter, so that the photographing apparatus acquires a second image matching the composition model.

When a device carrying the photographing apparatus is an aerial vehicle, an attitude of the photographing apparatus may be adjusted by adjusting a stability augmentation component of the aerial vehicle, a distance of the aerial vehicle relative to the target scene, a focal length of the photographing apparatus, or the like, so that the photographing apparatus acquires the second image matching the composition model. The matching between the second image and the composition model may mean that an outer contour, a position, and the like of a portrait in the second image are roughly consistent with an outer contour, a position, and the like of a portrait in the composition model. When a device carrying the photographing apparatus is a handheld gimbal, an attitude of the photographing apparatus may be adjusted by controlling and adjusting the gimbal.

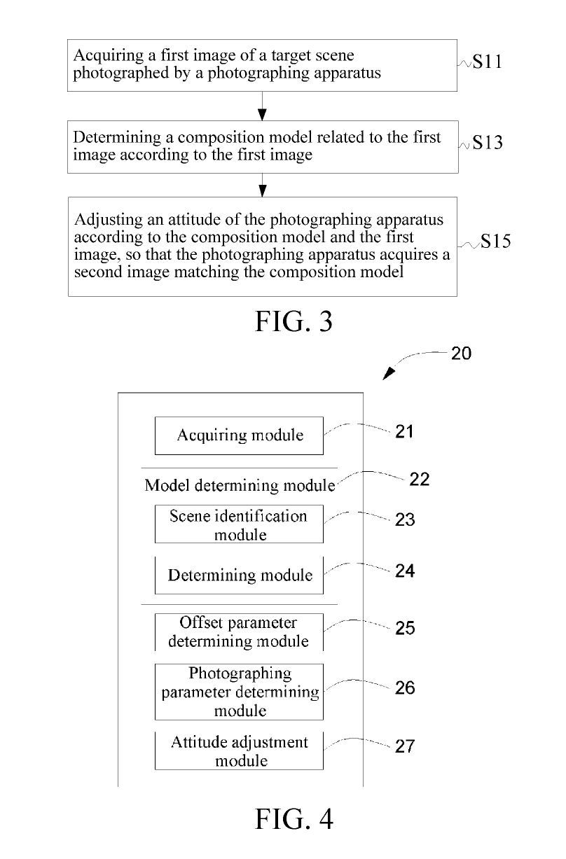

As shown in FIG. 3, another embodiment of the present application provides a photographing composition method. The method includes:

Step S11. Acquiring a first image of a target scene photographed by a photographing apparatus.

In this embodiment of the present application, the target scene may be a scene using a beach as a background, a scene using a building as a background, a scene using a remote mountain as a background, a scene using a mountain and a river and a building as a background, or the like. The first image may be a single-frame image of the target scene captured by the photographing apparatus.

Step S13. Determining a composition model related to the first image according to the first image.

In this embodiment of the present application, the composition model may be various composition models such as a composition model in which a person uses a beach as a background, a composition model in which a person uses a building as a background, a composition model in which a person uses a remote mountain as a background and a composition model in which a person uses a mountain and a river and a building as a background. The composition model may include feature information of the target scene, outer contour information of a portrait, position information of the portrait in the target scene, and the like.

Step S15. Adjusting an attitude of the photographing apparatus according to the composition model and the first image, so that the photographing apparatus acquires a second image matching the composition model.

In this embodiment of the present application, the first image captured by the photographing apparatus is inevitably different from the composition model. For example, the first image has a particular steep angle relative to a horizontal plane. For another example, an outer contour of a portrait in the first image is excessively large or small. For another example, the portrait in the first image is located to the left or right. Therefore, when a device carrying the photographing apparatus is an aerial vehicle, an attitude of the photographing apparatus may be adjusted by adjusting a stability augmentation component of the aerial vehicle, a distance of the aerial vehicle relative to the target scene, a focal length of the photographing apparatus, or the like, so that the photographing apparatus acquires the second image matching the composition model. The matching between the second image and the composition model may mean that an outer contour, a position, and the like of a portrait in the second image are roughly consistent with an outer contour, a position, and the like of a portrait in the composition model.

The embodiments of the present application disclose the photographing composition method. The first image of the target scene currently previewed by the photographing apparatus is acquired. Then, the composition model related to the first image is determined according to the first image. Finally, the attitude of the photographing apparatus is adjusted according to the composition model and the first image, so that the photographing apparatus acquires the second image matching the composition model. In this way, an image having a better composition design can be taken and operations are simple and convenient.

As shown in FIG. 4, an embodiment of the present application provides a photographing composition apparatus 20. The apparatus 20 includes an acquiring module 21, a model determining module 22, an offset parameter determining module 25, a photographing parameter determining module 26 and an attitude adjustment module 27.

The acquiring module 21 is configured to acquire a first image of a target scene photographed by a photographing apparatus.

The target scene may be a scene using a beach as a background, a scene using a building as a background, a scene using a remote mountain as a background, a scene using a mountain and a river and a building as a background, or the like. The first image may be a single-frame image of the target scene captured by the photographing apparatus.

The model determining module 22 is configured to determine a composition model related to the first image according to the first image. In an embodiment of the present application, the model determining module 22 includes a scene identification module 23 and a determining module 24. The scene identification module 23 is configured to identify a type to which the target scene belongs. The determining module 24 is configured to determine the composition model related to the first image.

In this embodiment of the present application, the composition model may be various composition models such as a composition model in which a person uses a beach as a background, a composition model in which a person uses a building as a background, a composition model in which a person uses a remote mountain as a background and a composition model in which a person uses a mountain and a river and a building as a background. The composition model may include feature information of the target scene, outer contour information of a portrait, position information of the portrait in the target scene, and the like.

The composition model may be prestored in the photographing composition apparatus 20, for example, prestored in a storage module of a device such as an aerial vehicle or a handheld gimbal. Types and a quantity of the composition models may be set according to an actual requirement.

The scene identification module 23 first identifies the type to which the target scene in the first image belongs, and then determines the type to which the target scene belongs. The determining module 24 selects, from a plurality of composition models, the composition model related to the first image according to the type to which the target scene belongs. For example, if the first image includes a target scene in which a person uses a beach as a background, the composition model related to the first image is a composition model in which a person uses a beach as a background. For another example, if the first image includes a target scene in which a person uses a remote mountain as a background, the composition model related to the first image is a composition model in which a person uses a remote mountain as a background.

The offset parameter determining module 25 is configured to determine an offset parameter of the first image relative to the composition model.

In this embodiment of the present application, if the first image does not match the composition model, that is, the first image captured by the photographing apparatus is different from the composition model, the offset parameter of the first image relative to the composition mode is determined. For example, the offset parameter may be a steep angle of the first image relative to a horizontal plane. For another example, the offset parameter may be a distance by which a portrait in the first image is located to the left or right.

The photographing parameter determining module 26 is configured to determine a photographing parameter related to the composition model according to the composition model. In this embodiment of the present application, the photographing parameter includes but is not limited to at least one of a focal length, chromaticity, brightness, contrast and an exposure level. The photographing parameter may be preset according to the type of the composition model, or may be adjusted according to a user operation.

The attitude adjustment module 27 is configured to adjust an attitude of the photographing apparatus according to the offset parameter and the photographing parameter, so that the photographing apparatus acquires a second image matching the composition model.

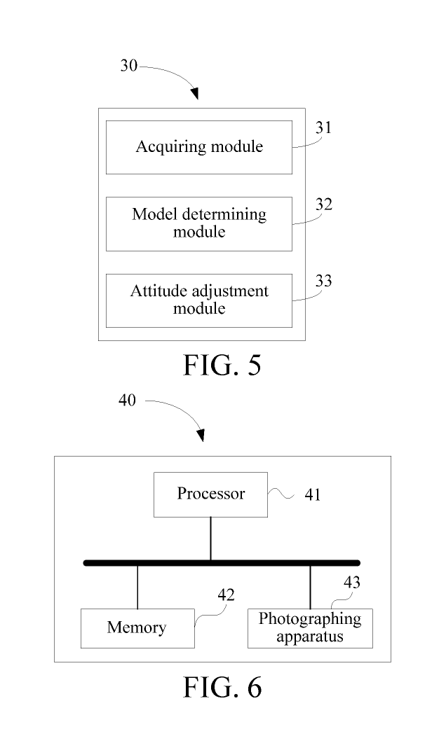

As shown in FIG. 5, another embodiment of the present application provides a photographing composition apparatus 30. The apparatus 30 includes an acquiring module 31, a model determining module 32 and an attitude adjustment module 33.

The acquiring module 31 is configured to acquire a first image of a target scene photographed by a photographing apparatus.

The model determining module 32 is configured to determine a composition model related to the first image according to the first image.

The attitude adjustment module 33 is configured to adjust an attitude of the photographing apparatus according to a offset parameter, so that the photographing apparatus acquires a second image matching the composition model.

For detailed descriptions of the acquiring module 31, the model determining module 32 and the attitude adjustment module 33, refer to the foregoing embodiment, and details are not described herein again.

FIG. 6 is a schematic diagram of a hardware structure of a movable object 40 according to an embodiment of the present application. The movable object 40 may include:

one or more processors 41, a memory 42 and a photographing apparatus 43. One processor 41 is used as an example in FIG. 6.

The processor 41, the memory 42 and the photographing apparatus 43 may be connected by using a bus or in other manners. A bus connection is used as an example in FIG. 6.

As a non-volatile computer-readable storage medium, the memory 42 may be configured to store a non-volatile software program, a non-volatile computer-executable program and a module, for example, a program instruction/module (for example, the acquiring module 31, the model determining module 32 and the attitude adjustment module 33 shown in FIG. 5 and the acquiring module 21, the model determining module 22, the offset parameter determining module 25, the photographing parameter determining module 26 and the attitude adjustment module 27 shown in FIG. 4) corresponding to the photographing composition method in the embodiments of the present application. The processor 41 and the photographing apparatus 43 run the non-volatile software program, the instruction and the module stored in the memory 42 to perform various function applications and data processing of the movable object 40, that is, to implement the photographing composition method in the foregoing method embodiments.

The memory 42 may include a program storage area and a data storage area. The program storage area may store an operating system and an application program required by at least one function. The data storage area may store data created according to use of the photographing composition apparatus. In addition, the memory 42 may include a high-speed random access memory, and may further include a non-volatile memory, for example, at least one magnetic disk storage device, a flash memory, or other non-volatile solid state memories. In some embodiments, the memory 42 may optionally include a memory remotely set relative to the processor 41, and the remote memory may be connected to the photographing composition apparatus through a network. Examples of the network include, but are not limited to, the Internet, an intranet, a local area network, a mobile communications network, or a combination thereof.

The one or more modules are stored in the memory 42. When executed by the one or more processors 41, the photographing composition method in any of the foregoing method embodiments is performed. For example, step S101 to step S106 in the method in FIG. 2 are performed, step S11 to step S15 in the method in FIG. 3 are performed, functions of the acquiring module 21, the model determining module 22, the offset parameter determining module 25, the photographing parameter determining module 26 and the attitude adjustment module 27 in FIG. 4 are performed, and functions of the acquiring module 31, the model determining module 32 and the attitude adjustment module 33 in FIG. 5 are performed.

The foregoing apparatuses may perform the photographing composition method provided in the embodiments of the present application and have corresponding function modules for performing the method and beneficial effects. For technical details not fully described in the embodiments, refer to the photographing composition method provided in the embodiments of the present application.

An embodiment of the present application further provides a computer-readable storage medium. The computer-readable storage medium stores a computer-executable instruction. The computer-executable instruction is executed by one or more processors, for example, the processor 41 in FIG. 6, so that the foregoing one or more processors can perform the photographing composition method in any of the foregoing method embodiments, for example, perform step S101 to step S106 in the method in FIG. 2, step S11 to step S15 in the method in FIG. 3, functions of the acquiring module 21, the model determining module 22, the offset parameter determining module 25, the photographing parameter determining module 26 and the attitude adjustment module 27 in FIG. 4, and functions of the acquiring module 31, the model determining module 32 and the attitude adjustment module 33 in FIG. 5.

The foregoing described apparatus embodiments are merely examples. The units described as separate components may be or may not be physically separated. The component displayed as a unit may be or may not be a physical unit, that is, may be located at one place or may be distributed onto a plurality of network units. The objectives of the solutions of the embodiments may be achieved by using some or all of the modules according to an actual requirement.

Through the above descriptions of the implementations, it is clear to a person skilled in the art that the implementations may be implemented by software plus a universal hardware platform, or may certainly be implemented by hardware. A person of ordinary skill in the art may understand that all or parts of procedures of the methods in the foregoing embodiments may be implemented by a computer program instructing relevant hardware. The program may be stored in a computer-readable storage medium. When the program is executed, the procedures of the methods in the embodiments may be included. The storage medium may be a magnetic disk, an optical disc, a read-only memory (ROM), a random access memory (RAM), or the like.

Finally, it should be noted that, the foregoing embodiments are used only for describing the technical solutions of the present application, but not for limiting the technical solutions. According to the idea of the present application, technical features in the foregoing embodiments or different embodiments may be combined, steps may be performed in any sequence and there are many other variations described above in different aspects of the present application. For brevity, they are not provided in detail. Although the present application is described in detail by referring to the foregoing embodiments, a person of ordinary skill in the art should understand that, the person still may modify the technical solutions recorded in the foregoing embodiments, or equivalently replace some technical features thereof. These modifications or replacements do not make the nature of the corresponding technical solutions depart from the scope of the technical solutions of the embodiments of the present application.

What is claimed is:

1. A photographing composition method, comprising:
acquiring a first image of a target scene photographed by a photographing apparatus;
determining a composition model related to the first image according to the first image; and
adjusting an attitude of the photographing apparatus according to the composition model and the first image, so that the photographing apparatus acquires a second image matching the composition model.

2. The method according to claim 1, wherein the determining the composition model related to the first image according to the first image comprises:
identifying, according to the first image, a type to which the target scene belongs; and
determining the composition model related to the target scene according to the type to which the target scene belongs.

3. The method according to claim 1, wherein the adjusting the attitude of the photographing apparatus according to the composition model and the first image, so that the photographing apparatus acquires the second image matching the composition model comprises:
determining an offset parameter of the first image relative to the composition model; and
adjusting the attitude of the photographing apparatus according to the offset parameter, so that the photographing apparatus acquires the second image matching the composition model.

4. The method according to claim 2, wherein the adjusting the attitude of the photographing apparatus according to the composition model and the first image, so that the photographing apparatus acquires the second image matching the composition model comprises:
determining an offset parameter of the first image relative to the composition model; and
adjusting the attitude of the photographing apparatus according to the offset parameter, so that the photographing apparatus acquires the second image matching the composition model.

5. The method according to claim 1, wherein the method further comprises:
determining a photographing parameter related to the composition model according to the composition model; and
acquiring, according to the photographing parameter, the second image matching the composition model.

6. The method according to claim 5, wherein the photographing parameter comprises at least one of a focal length, chromaticity, brightness, contrast and an exposure level.

7. A movable object, comprising a body, a controller disposed in the body and a photographing apparatus disposed on the body, wherein the controller is configured to:
acquire a first image of a target scene photographed by the photographing apparatus;
determine a composition model related to the first image according to the first image; and
adjust an attitude of the photographing apparatus according to the composition model and the first image, so that the photographing apparatus acquires a second image matching the composition model.

8. The movable object according to claim 7, wherein the controller is specifically configured to:
identify, according to the first image, a type to which the target scene belongs; and
determine the composition model related to the target scene according to the type to which the target scene belongs.

9. The movable object according to claim 7, wherein the controller is specifically configured to:
determine an offset parameter of the first image relative to the composition model; and
adjust the attitude of the photographing apparatus according to the offset parameter, so that the photographing apparatus acquires the second image matching the composition model.

10. The movable object according to claim 8, wherein the controller is specifically configured to:
determine an offset parameter of the first image relative to the composition model; and
adjust the attitude of the photographing apparatus according to the offset parameter, so that the photographing apparatus acquires the second image matching the composition model.

11. The movable object according to claim 7, wherein the controller is specifically configured to:
determine a photographing parameter related to the composition model according to the composition model; and
control the photographing apparatus to acquire, according to the photographing parameter, the second image matching the composition model.

12. The movable object according to claim 11 wherein the photographing parameter comprises at least one of a focal length, chromaticity, brightness, contrast and an exposure level.

13. The movable object according to claim 7, wherein the movable object further comprises a memory configured to store the composition model.

14. The movable object according to claim 7, wherein the movable object comprises an aerial vehicle or a handheld photographing device.

15. A movable object, comprising a memory and a processor, wherein the memory stores a computer program, and when the computer program is executed by the processor, and the processor is configured to:
acquire a first image of a target scene photographed by the photographing apparatus;
determine a composition model related to the first image according to the first image; and
adjust an attitude of the photographing apparatus according to the composition model and the first image, so that the photographing apparatus acquires a second image matching the composition model.

16. The movable object according to claim 15, wherein the processor is specifically configured to:
identify, according to the first image, a type to which the target scene belongs; and
determine the composition model related to the target scene according to the type to which the target scene belongs.

17. The movable object according to claim 15, wherein the processor is specifically configured to:
determine an offset parameter of the first image relative to the composition model; and
adjust the attitude of the photographing apparatus according to the offset parameter, so that the photographing apparatus acquires the second image matching the composition model.

18. The movable object according to claim 15, wherein the processor is specifically configured to:
determine a photographing parameter related to the composition model according to the composition model; and
control the photographing apparatus to acquire, according to the photographing parameter, the second image matching the composition model.

19. The movable object according to claim 18 wherein the photographing parameter comprises at least one of a focal length, chromaticity, brightness, contrast and an exposure level.

20. The movable object according to claim 15, wherein the movable object further comprises a memory configured to store the composition model.
